(19) United States
(12) Patent Application Publication
(10) Pub. No.: US 2026/0361465 A1
(43) Pub. Date: Nov. 12, 2026

(54) OMAMRC method and system with FDM transmission and multiple cooperations per sub-band

(71) Applicant: ORANGE, ISSY LES MOULINEAUX (FR)

(72) Inventors: Ali AL KHANSA, Chatillon (FR); Raphaël VISOZ, Chatillon (FR)

(21) Appl. No.: 19/118,925

(22) PCT Filed: Oct. 11, 2023
(86) PCT No.: PCT/EP2023/078125

§ 371 Date: Apr. 7, 2025

(30) Foreign Application Priority Data
Oct. 14, 2022 (FR) FR2210584

(51) Int. Cl. H04L 1/1812

(52) U.S. Cl. CPC H04L 1/1819

(57) ABSTRACT

A method for transmitting messages for an OMAMRC telecommunication system having N nodes, including M sources, optionally L relays and one destination. The transmission is FDM transmission in a band divided into B mutually orthogonal sub-bands. The method includes: transmitting M first redundancies of the M messages of the M sources during the 1^{st} phase; receiving, via the nodes, scheduling information indicating, per sub-band, a selected source which is not yet correctly decoded by the destination, the scheduling information taking into account a constraint of a maximum emission power per node; and transmitting, on a single sub-band during a single retransmission interval of the 2^{nd} phase, active nodes having correct knowledge of a single selected source of a single second redundancy of a single message of a single source, transmission of one node over a plurality of sub-bands being under constraint of a maximum emission power of the node.

### FIELD OF THE INVENTION

The present invention relates to the field of digital communications. In this field, the invention more specifically relates to the transmission of coded data between at least two sources and a destination with relaying by the cooperation of at least one node, which can be one of the sources or a relay separate from a source.

It is understood that a relay does not have a message to be transmitted. A relay is a node dedicated to relaying messages from sources, while a source has its own message to be transmitted and can also, in some cases, relay the messages from the other sources, i.e. the source is said to be cooperative in this case.

Many relaying techniques exist, namely: “amplify and forward”, “decode and forward”, “compress and forward”, “non-orthogonal amplify and forward”, “dynamic decode and forward”, etc.

The invention notably, but not exclusively, applies to the transmission of data via mobile networks, for example for real-time applications, or via sensor networks, for example. Such a sensor network is a multi-user network, made up of several sources, several relays and a recipient using an orthogonal multiple access scheme of the transmission channel between the relays and the destination, denoted OMAMRC (Orthogonal Multiple Access Multiple Relay Channel).

### PRIOR ART

An OMAMRC transmission system implementing frequency division multiplexing (FDM) type transmission is known from application WO 2021/260308 published on 30 Dec. 2021. The OMAMRC telecommunication system described, illustrated in FIG. 1, comprises M sources that belong to the set of sources [symbol] ={1, . . . , M}, optionally L relays that belong to the set of relays [symbol] ={M+1, . . . , M+L}, M≥2, L≥0, and a destination d. Each source of the set [symbol] communicates with the single destination with the assistance of the other sources (user cooperation) and relays that cooperate. The nodes comprise the relays and the sources that can act as a relay when they do not transmit their own message.

The nodes, M sources and L relays access the transmission channel according to an orthogonal frequency multiple access scheme and operate according to a full-duplex mode that allows them to listen to the transmissions of the other nodes without any interference.

The channel band is divided into B sub-bands, the number of which is assumed to be greater than or equal to the number of sources: B≥M. Each sub-band associated with a time slot determines F channel uses (F resource elements). For each time slot, the FDM transmission occurs over the band divided into B mutually orthogonal sub-bands.

A transmission cycle of a frame, illustrated in FIG. 2, lasts 1+T_{used} time slots, with T_{used}≤Tₘₐₓ and Tₘₐₓ being the maximum number of time slots for a transmission cycle. For each time slot, none, one or more sub-bands are allocated to a node according to a partition and each sub-band is allocated for each time slot to at most one node.

During the first time slot (first phase) all the sources x₁, . . . , x_{M} transmit, assuming that B≥M, respectively over one or more sub-bands allocated to each source.

During the next slots, called retransmission slots (second phase), only the nodes selected from among the sources and the relays transmit and their transmission occurs over the one or more sub-bands that are respectively allocated to them according to a partition determined for each current slot. Thus, for each of these slots, the destination determines the vector âₜ∈( [symbol] ∪ [symbol] )^{B} of dimension B of the nodes to be transmitted for the slot t subject to the constraint that each sub-band is allocated to at most one node.

The selected node for cooperative transmission transmits uₐ_{ₜ}, after multi-user coding, the words it has correctly decoded. The selected node can transmit parities determined from the messages of its correctly decoded source set using network coding and Joint Network Channel Coding. The other nodes and the destination can improve their own decoding by exploiting the transmission of the selected node and can accordingly update their set of correctly decoded sources.

The destination thus controls the transmission of the nodes using a feedback channel. This allows spectral efficiency and reliability to be improved by increasing the probability of the destination decoding all the sources.

### Main Features of the Invention

The aim of the present invention is a method for transmitting framed messages intended for a telecommunication system comprising a destination and N nodes, including M sources and N-M relays, N≥M≥2, with orthogonal multiple access to the transmission channel between the N nodes, with a maximum number of T+Tₘₐₓ time slots per transmitted frame distributed between a 1st phase of T time slots and a 2^{nd} phase of at least one time slot, called retransmission time slot, 1≤Tₘₐₓ, with the message of a source having been coded before transmission according to incremental redundancy type coding that generates several redundancies, the transmission being of the frequency division multiplexing type over a band divided into B≥2 mutually orthogonal sub-bands, M≤BT. The method is such that it comprises:
transmitting M first redundancies of the M messages of the M sources during the 1^{st} phase;
receiving, via the nodes, scheduling information indicating, per sub-band, a selected source, called source to be assisted, not yet correctly decoded by the destination, the scheduling information taking into account a constraint of a maximum transmission power per node;
transmitting, over the same sub-band for the same retransmission slot of the 2^{nd} phase, nodes, called active nodes, with correct knowledge of the same selected source, with the same second redundancy of the same message of the same source, with the transmission of a node over several sub-bands being subject to the constraint of a maximum transmission power of the node.

The allocation of orthogonal sub-bands between the sources allows the time required to transmit data to be reduced since all the sources transmit their first redundancy over one or more sub-bands of one of the T time slots of the 1^{st} phase. When the 1^{st} phase comprises a single time slot, T=1, then all the sources simultaneously transmit during this same time slot, which allows a very fast 1^{st} phase to be provided. Such a method is therefore well adapted for services that are demanding in terms of latency.

Transmitting the same redundancy simultaneously during the same retransmission slot of the 2^{nd} phase via all the nodes with correct knowledge of the same source allows the power to be increased upon reception at the destination and thus allows the probability of a false alarm to be significantly reduced, i.e. incorrect decoding. This improvement optimizes the throughput and/or allows the transmission power of the sources to be reduced for the same throughput.

Nodes with correct knowledge of the same source are equally the nodes that have correctly decoded this same source as well as the source itself. These nodes other than the source are capable of cooperating by transmitting the same redundancy for this same source during a retransmission slot. The transmission of these nodes is said to be cooperative.

In the case whereby the system includes relays other than the sources, a cooperative transmission is either a transmission by a relay or a transmission by a source capable of assisting the destination to decode a source that it has not yet correctly decoded.

A cooperative transmission is a transmission via a node that contains information relating to at least one message from another node. The transmission of a relay is, by nature, a cooperative transmission, but also the transmission of a source (which is capable of cooperating) that includes information in its transmission that relates to at least one message from another source.

The cooperation of the nodes ensures an increase in the reliability of the transmissions.

The transmission of a node over a sub-band depends on its transmission over other sub-bands. Indeed, a node has a transmission power P that must be distributed over all the sub-bands for which it is active. The power transmitted by a node for a sub-band is a function of its power transmitted over the other sub-bands for which it is active and the sum of the transmitted powers per band cannot exceed P.

The selection of the sources to be assisted is implemented by a device, called scheduler, which can equally correspond to the destination as to another device with knowledge concerning the quality of the links within the considered system.

The scheduler feeds back scheduling information to the nodes identifying the selected sources to be assisted, i.e. selected from among the sources that the destination has not yet correctly decoded. The scheduling information further comprises allocating sub-bands in order for the nodes to retransmit a redundancy of the selected sources. For example, this information can be in the form of an integer Q: for B sub-bands, this integer Q can be determined as follows, Q=p₀+p₁M+ . . . +p_{B-1}M^{B-1}, where pᵢ+1 is the identifier of the source assuming its value in the set {1, . . . , M} associated with the i^{th}+1 band assuming its value in the set {1, . . . , B}.

A further aim of the invention is a method for transmitting framed messages implemented by a telecommunication device intended for a telecommunication system with N nodes, including M sources and N-M relays and the device, N≥M≥2, with orthogonal multiple access to the transmission channel between the N nodes, with a maximum number of T+Tₘₐₓ time slots per transmitted frame distributed between a 1^{st} phase of T time slots and a 2^{nd} phase of at least one time slot, called retransmission time slot, 1≤Tₘₐₓ, with the message of a source having been coded before transmission according to incremental redundancy type coding that generates several redundancies, the transmission being of the frequency division multiplexing type over a band divided into B mutually orthogonal sub-bands, M≤BT. The method is such that it comprises:
simultaneously receiving, by the device during the 1^{st} phase over at least M sub-bands, M first redundancies of the M messages of the M sources;
the device transmitting scheduling information indicating, per sub-band, a selected source, called source to be assisted, not yet correctly decoded by the device, with the scheduling information taking into account a constraint of a maximum transmission power per node;
the device receiving, over the same sub-band for the same retransmission time slot of the 2^{nd} phase, the same second redundancy of the same selected source and originating from various nodes with correct knowledge of this same source.

A further aim of the invention is a method for transmitting framed messages implemented by a telecommunication device intended for a telecommunication system with N nodes, including M sources and N-M relays and a destination, N≥M≥2, the device being one of the sources, with orthogonal multiple access to the transmission channel between the N nodes and the destination, with a maximum number of T+Tₘₐₓ time slots per transmitted frame distributed between a 1^{st} phase of T time slots and a 2^{nd} phase of at least one time slot, called retransmission time slot, 1≤Tₘₐₓ, with the transmission being of the frequency division multiplexing type over a band divided into B mutually orthogonal sub-bands, M≤BT. The method is such that it comprises:
coding a message before transmission according to incremental redundancy type coding that generates several redundancies;
transmitting a first redundancy of a message from the source during the 1^{st} phase; receiving scheduling information indicating, per sub-band, a selected source, called source to be assisted, not yet correctly decoded by the destination, with the scheduling information taking into account a constraint of a maximum transmission power per node;
transmitting, during a retransmission slot of the 2^{nd} phase, a second redundancy of the message of the selected sources over the respective sub-bands, for the sources for which the device has correct knowledge, with the transmission of the device over several sub-bands being subject to the constraint of a maximum transmission power.

A further aim of the invention is a telecommunication device for transmitting framed messages, intended for a telecommunication system comprising N nodes, including M sources and N-M relays, N≥M≥2, and a destination d, with orthogonal multiple access to the transmission channel between the N nodes and the destination, with a maximum number of T+Tₘₐₓ time slots per transmitted frame distributed between a 1^{st} phase of T time slots and a 2^{nd} phase of at least one time slot, called retransmission time slot, 1≤Tₘₐₓ, the transmission being of the frequency division multiplexing type over a band divided into B≥2 mutually orthogonal sub-bands, M≤BT, the device that corresponds to one of the sources comprises at least one microprocessor, a memory, a transmission chain and a reception chain, the transmission chain comprises a coder implementing incremental redundancy type coding that generates multiple redundancies of the same message to be transmitted, and is such that:
the transmission chain is able to transmit a first redundancy of the message to be transmitted during the 1^{st} phase;
the reception chain is able to receive scheduling information St of size B indicating, per sub-band, a selected source, called source to be assisted, not yet correctly decoded by the destination, the scheduling information taking into account a constraint of a maximum transmission power per node;
the transmission chain is also able to transmit, during a retransmission slot of the 2^{nd} phase, a second redundancy of the message of the selected sources over the respective sub-bands, for the sources for which the device has correct knowledge, with the transmission over several sub-bands being subject to the constraint of a maximum transmission power.

A further aim of the invention is a telecommunication device for transmitting framed messages, intended for a telecommunication system comprising N nodes, including M sources and N-M relays, N≥M≥2, and a destination d, with orthogonal multiple access to the transmission channel between the N nodes and the destination, with a maximum number of T+Tₘₐₓ time slots per transmitted frame distributed between a 1^{st} phase of T time slots and a 2^{nd} phase of at least one time slot, called retransmission time slot, 1≤Tₘₐₓ, the transmission being of the frequency division multiplexing type over a band divided into B≥2 mutually orthogonal sub-bands, M≤BT. The device that corresponds to one of the sources comprises at least one microprocessor, a memory, a transmission chain and a reception chain, and is such that:
the reception chain is able to simultaneously receive, during the 1^{st} phase over at least M sub-bands, M first redundancies of the M messages of the M sources;
the transmission chain is able to transmit scheduling information indicating, per sub-band, a selected source, called source to be assisted, not yet correctly decoded by the device, the scheduling information taking into account a constraint of a maximum transmission power per node;
the reception chain is also able to receive, over the same sub-band for the same retransmission slot of the 2^{nd} phase, the same second redundancy of the same selected source and originating from various nodes with correct knowledge of this same source.

A further aim of the invention is a telecommunication system comprising a destination and N nodes, including M sources and N-M relays, M≥2, with orthogonal multiple access to the transmission channel between the N nodes and the destination, able to implement a transmission method according to one of the aims of the invention.

According to one embodiment, the scheduling information is determined based on mutual information per sub-band b,

$${I}_{{A}_{{s}_{b}}} ,$$

of an equivalent channel between the nodes with correct knowledge of the same source to be assisted and the destination.

The criterion taken into account based on the mutual information means it is possible to tend toward maximization of the spectral efficiency. The mutual information depends on the number of sub-bands for which a node is active, i.e. which transmits redundancy for the same source or for several sources for these various sub-bands. The selection of the sources to be assisted therefore takes into account the fact that each node that transmits a redundancy of a selected source to be assisted transmits over the allocated sub-bands and this is the case for the various sources to be assisted for which it has correct knowledge. Determining the scheduling information is therefore subject to the constraint of a maximum transmission power per node.

According to one embodiment, the transmission method further comprises:
transmitting sets of sources correctly decoded by the nodes at the end of the transmission slot of the 1^{st} phase.

The information transmitted by the nodes allows the destination to select the sources to assist it to decode a maximum number of sources.

According to one embodiment, the transmission method further comprises:
receiving, via the nodes, a set of sources correctly decoded by the destination from among the sources received by the destination during the 1^{st} phase;
transmitting, via the nodes, sets of sources correctly decoded by the nodes and not yet correctly decoded by the destination at the end of the 1^{st} phase.

According to this protocol, the destination feeds back its set of correctly decoded sources to the nodes after receiving data transmitted during the 1^{st} transmission slot. This feeding back can occur via a control channel. According to a particularly simple embodiment, the destination feeds back M bits that indicate, for each of the M sources, whether or not it is correctly decoded. If all the sources are correctly decoded by the destination, i.e. its set of correctly decoded sources contains the M sources, a new frame is transmitted. The information transmitted by the nodes allows the destination to more efficiently select the sources to assist it in decoding a maximum number of sources.

According to one embodiment, the scheduling information is obtained by comparing, between different possible scheduling information of sources to be assisted per sub-band, the sum on the sub-bands B of mutual information per sub-band b of an equivalent channel between the nodes with correct knowledge of the same source to be assisted and the destination.

According to one embodiment, with the scheduling information comprising B components, the components are determined sequentially, sub-band after sub-band and, for a given sub-band b, the component is obtained by determining, between the various sources to be assisted, a maximum of a sum comprising, on the one hand, the sum on the sub-bands of 1 to b−1 of mutual information of an equivalent channel between the nodes with correct knowledge of the same source to be assisted and the destination and, on the other hand, mutual information of an equivalent channel between the nodes with correct knowledge of the same source to be assisted and the destination for the sub-band b.

According to one embodiment, a transmission channel between a node a taken from among the N nodes and the destination for the sub-band b is expressed as h_{a,b}e^{-jφ}^{_{a,b}}, with h_{a,b} being an amplitude and φ_{a,b} being a phase factor, the method is such that, when each of the nodes with correct knowledge of the same selected source knows the phase φ_{a,b} of the transmission channel between this node a and the destination, the transmission, by each of these nodes, of the same second redundancy of this same source is modulated by the phase factor e^{-jφ}^{_{a,b}}=

$${h}_{a , b}^{*} / \vert {h}_{a , b} \vert ,$$

with j²=−1 and where

$${h}_{a , b}^{*} / \vert {h}_{a , b} \vert$$

corresponds to the conjugate

$${h}_{a , b}^{*}$$

of the amplitude h_{a,b} of the transmission channel between this node and the destination divided by its norm h_{a,b}.

According to one embodiment, a transmission channel between a node a taken from among the N nodes and the destination for the sub-band b is expressed as h_{a,d} e^{-jφ}^{_{a,b}}, with h_{a,d} being an amplitude and φ_{a,b} being a phase factor, with the nodes with correct knowledge of the same selected source for the sub-band b being grouped into a first and a second group of nodes, such that each node of the first group knows the phase φ_{a,b} of the transmission channel between this node and the destination for the sub-band b and each node of the second group does not know the phase φ_{a,b} of the transmission channel between this node and the destination for the sub-band b, the method is such that the transmission via a node a of the first group of the same second redundancy of a source is modulated by the phase factor

$${e}^{- {j φ}_{a , b}} = {h}_{a , b}^{*} / \vert {h}_{a , b} \vert ,$$

with j²=−1 and where

$${h}_{a , b}^{*} / \vert {h}_{a , b} \vert$$

corresponds to the conjugate

$${h}_{a , b}^{*}$$

of the amplitude h_{a,b} of the transmission channel between this node a and the destination divided by its norm |h_{a,b}|, and such that the transmission via a node a of the second group of the same second redundancy of the source occurs without phase correction.

According to one embodiment, for the same source, the first redundancy and the second redundancy are different.

The various embodiments can be combined with each other to form other embodiments.

The devices and the system according to the invention are able to implement the various embodiments of the method according to the invention.

A further aim of the invention is each of the specific software applications on one or more information media, with said applications comprising program instructions able to implement the transmission method when these applications are executed by processors.

A further aim of the invention is configured memories comprising instruction codes respectively corresponding to each of the specific applications.

The memory can be incorporated into any entity or device capable of storing the program. The memory can be of the ROM type, for example a CD ROM or a microelectronic circuit ROM, or even of the magnetic type, for example a USB key or a hard disk.

Moreover, each specific application according to the invention can be downloaded from a server accessible over an Internet-type network.

The optional features set forth above within the scope of the transmission method optionally can apply to the aforementioned software application and the memory.

### LIST OF FIGURES

Further features and advantages of the invention will become more clearly apparent upon reading the following description of embodiments, which are provided by way of simple illustrative and non-limiting examples, and the appended drawings, in which:

FIG. 1 is a diagram of an example of an OMAMRC (Orthogonal Multiple Access Multiple Relay Channel) system according to the prior art;

FIG. 2 is a diagram of a transmission cycle of a frame according to the prior art;

FIG. 3 is a diagram of a transmission cycle of a frame according to the invention;

FIG. 4 is a diagram of the protocol of exchanges of information between the destination and the nodes, sources and relays, according to one embodiment of the invention;

FIG. 5 is a diagram of the simplified structure of a telecommunication device according to the invention.

### DESCRIPTION OF PARTICULAR EMBODIMENTS OF THE INVENTION

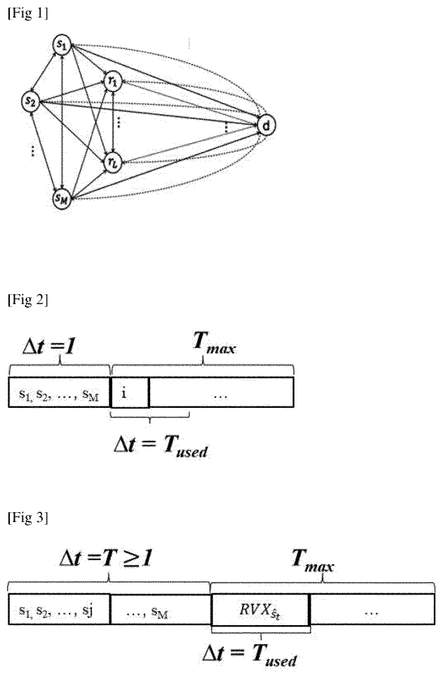

An OMAMRC system is illustrated in FIG. 1. Within the context of the invention, such a system comprises N nodes, including M sources that belong to the set of sources [symbol] ={1, . . . , M} and L=N−M relays that belong to the set of relays [symbol] ={M+1, . . . , M+L} and a destination d. L≥0. N≥M≥2. When N=M, the system comprises only two sources and the destination. When N>M, the system comprises at least two sources and at least one relay and the destination.

A diagram of a transmission cycle of a frame according to the invention is illustrated in FIG. 3.

A channel use is the smallest time-frequency resource granularity defined by the system that allows a modulated symbol to be transmitted. The number of channel uses is related to the available frequency band and the transmission duration.

Each source of the set [symbol] communicates with the single destination with the assistance of the other sources (also referred to as user cooperation) and the cooperating relays.

The nodes include the relays and the sources that can act as a relay when they do not transmit their own message.

The N nodes, M sources and L relays access the transmission channel according to an orthogonal frequency multiple access scheme and operate according to a full-duplex mode that allows them to listen to the transmissions of the other nodes without any interference.

The channel band is divided into B sub-bands. Each sub-band associated with a time slot t determines F channel uses (F resource elements). In the case of a transmission with OFDM modulation, a sub-band can comprise, for example, as many sub-carriers as an OFDM symbol. Each source transmits its framed data to the destination with the assistance of the other sources and relays. A frame occupies time slots when transmitting the M messages of the M sources, respectively.

A transmission cycle, i.e. the transmission of a frame, as illustrated in FIG. 3, occurs during T+T_{used} time slots. T≥1 is the number of transmission slots of the 1^{st} phase with one or more sub-bands of the channel allocated for each source i. T_{used} is the number of retransmission slots of the 2^{nd} phase with one or more sub-bands of the channel allocated to assist each selected source i, T_{used}≤Tₘₐₓ and Tₘₐₓ is the maximum number of retransmission slots.

Determining the sources to be assisted and the allocation of the sub-bands are implemented by a scheduler. The described embodiment corresponds to the case whereby the scheduler is hosted by the destination.

The number of channel uses is assumed to be identical for each transmission time slot and each retransmission time slot: B×F.

Rₛ is a variable representing the initial throughput of the source s that can assume its values in the finite set {R̅₁, . . . , R̅ₙ_{_{MCS}}}. The capacity of a transmission slot is N_{1,i} channel uses for each source i. During the first phase, each source s∈ [symbol] transmits a message during N_{1,s} channel uses, k∈{1, . . . , N_{1,s}}, with the number N_{1,s} of channel uses depending on the source s. The capacity of a retransmission slot is N₂ channel uses for each source i. αₛ is a variable representing the ratio N₂/N_{1,s}, which can assume its values in a finite set {α̅₁, . . . , α̅_{|A|}}. The initial throughputs of the sources are generally determined by the destination during an initial phase that precedes any transmission phase. The return of the initial throughputs R̅ᵢ and the ratios α̅ᵢ is carried out via very limited throughput control channels. The initial phase occurs at most before each transmission phase of a frame.

When T=1, then the number of sub-bands is assumed to be greater than or equal to the number of sources: B≥M. When T>1, then the number of sub-bands times the number of transmission slots is assumed to be greater than or equal to the number of sources: BT≥M.

An embodiment of the protocol of the exchanges between the nodes and the destination is illustrated in FIG. 4.

During the first phase, for the T first time slots, all the sources respectively transmit over one or more sub-bands allocated to each source. The allocation of one or more sub-bands to a source is defined in a partition that can be determined by the destination and communicated to the sources by the destination via a control channel. When T=1, all the sources simultaneously respectively transmit over one or more sub-bands allocated to each source. When T>1, all the sources transmit during one or more of the transmission slots over one or more sub-bands allocated to each source. Some sources can simultaneously transmit over various sub-bands. For each retransmission time slot, none, one or more sub-bands are allocated for a source to be assisted.

The scheduler, the destination according to the described embodiment, transmits scheduling information to the nodes that can assume the form of a vector. The scheduling information st determines a partition for the sources to be assisted for the various sub-bands. Thus, the partitions can be different between each of the retransmission slots. Only the nodes with correct knowledge of the same source of the partition simultaneously transmit the same redundancy for this same source over one or more of the same sub-bands. These nodes comprise the nodes that have correctly decoded this same source and the source itself; these nodes are said to be cooperative.

By way of a simplification of the description, the following assumptions are subsequently made concerning the OMAMRC system:
the sources and the relays are equipped with a single transmit antenna;
the sources, the relays, and the destination are equipped with a single receive antenna;
the sources, the relays, and the destination are perfectly synchronized;
the sources are statistically independent (there is no correlation between them);
all the nodes transmit with the same maximum power P;
a CRC code is used that is assumed to be included in the Kᵢ information bits of each source i in order to determine whether or not a message is correctly decoded, i∈ [symbol] ;
the links between the various nodes experience additive noise and fading. The fading gains are fixed during the transmission of a frame carried out for a maximum duration of T+Tₘₐₓ time slots, but can change independently from one frame to another. T≥1 and Tₘₐₓ≥1 are system parameters;
the instantaneous quality of the channel/direct link on reception (CSIR Channel State Information at Receiver) is available to the destination, the sources and the relays;
any feedback is error-free (no error on the control signals).

The following notations are used:
a node that intervenes during the 2^{nd} phase is denoted rᵢ with i∈{1, . . . , M+L}, if i≤M the node i is a source i denoted sᵢ in FIG. 1, i∈{1, . . . , M}, otherwise i>M, i∈{M+1, . . . , M+L} and the node is a relay denoted r₁, . . . , r_{L} in FIG. 1;
sₜ is the scheduling information. It contains the sources to be assisted for the retransmission slot t during the second phase. When it assumes the form of a vector, sₜ∈( [symbol] )^{B}, the scheduling information is of dimension B. The i^{th} element s_{t,b} of the vector sₜ indicates the source to be assisted for this b^{th} sub-band during this time slot t, b∈{1, . . . , B}. The order in the vector St corresponds to the order of the sub-bands. The scheduling information can assume other forms; this information can be, for example, in the form of an integer Q. For B sub-bands, this integer Q can be determined as follows: Q=p₀+p₁M+ . . . +p_{B-1}M^{B-1}, where pᵢ+1 is the identifier of the source assuming its value in the set {1, . . . , M} associated with i^{th}+1 band assuming its value in the set {1, . . . , B}. For example, an ordered set of three elements belonging to {0, . . . , 9}, for example (1, 2, 3), can be expressed (it is a bijection) in the form of an integer Q=321 or 1+2× 10+3×10² in base 10. An ordered set of three elements belonging to {0, . . . , M−1}, for example (p₁, p₂, p₃), can be expressed (there is a bijection) in base M in the form of an integer Q=p₁+p₂×M+p₃×M². Therefore, the datum of a base integer M allows an ntuple to be identified whose elements are integers of a set {0, . . . , M−1}. The remainder of the description considers that the scheduling information assumes the form of a vector.
γ_{a,c} is the average signal-to-noise ratio (SNR) that takes into account the effects of path loss and shadowing between the node a (source or relay) and the node c (source, relay or destination).
h_{a,c} is the path loss gain (fading) between the node a (source or relay) and the node c (source, relay or destination) that follows a complex circularly-symmetric Gaussian distribution with zero mean and variance γ_{a,c}; the gains are independent of each other.
nₜ∈({0, . . . , B})^{M+L} is the vector of dimension M+L of the number of sub-bands for which a node is active, or not active, for assisting one or more sources that varies between 0 (the node is not active) and B (the node is active for all the sub-bands) for the retransmission slot (time slot) t during the second phase. The i^{th} element n_{t,i} of the vector nₜ denotes the number of sub-bands for which the node i, source or relay, is active for the retransmission slot (time slot) t, i∈{1, . . . , M+L}.
T_{used} is the number of retransmission time slots, i.e. during the second phase that results in zero faults for all the sources (the individual cut-off event for each source is zero, i.e. [symbol] _{i,t}=0):

$${T}_{used} = {min}_{t \leq {T}_{max}} t such that ( {𝔒}_{i , t} = 0 ∀ i ∈ \{ 1 , … , M \} or t = {T}_{max} ) \qquad ( 1 )$$

### Example of the Implementation of the Invention

During the first phase, each source s∈ [symbol] transmits after coding a message uₛ comprising Kₛ information bits uₛ∈

$${\text{?}}_{2}^{{K}_{s}} ,$$

with [symbol] being the two-element Galois field. The message uₛ comprises a CRC-type code that allows the integrity of the message uₛ to be checked. The message uₛ is coded according to the initial MCS. Given that the initial MCSs can be different between the sources, the lengths of the coded messages can be different between the sources. The coding uses an incremental redundancy code. The obtained codeword is segmented into redundancy blocks. The incremental redundancy code can be of the systematic type; the information bits are then included in the first redundancy. Whether or not the incremental redundancy code is of the systematic type, it is such that the first redundancy can be decoded independently of the other redundancies. The incremental redundancy code can be generated, for example, by means of a finite family of rate compatible punctured linear codes or rateless codes modified to operate with finite lengths: raptor code (RC), rate compatible punctured turbo code (RCPTC), rate compatible punctured convolutional code (RCPCC), rate compatible low density parity check code (RCLDPC). According to the embodiment described and illustrated in FIG. 4, the parameter T=1. Thus, during the first phase, the M sources simultaneously transmit a 1^{st} redundancy of their respective messages RV1ₛ_{₁}, . . . , RV1ₛ_{_{M}} during the transmission slot, respectively over the allocated sub-bands, respectively with modulation and coding schemes that are determined from the values of the initial throughputs of the sources.

With each transmitted message corresponding to a source s∈ [symbol] , a correctly decoded message is assimilated to the corresponding source for the purposes of notation.

Whether during the first phase or the second phase, when a node, in particular a source, transmits, the destination and the other nodes listen. Each full-duplex node can transmit over one or more sub-bands and simultaneously listen to all the other nodes that transmit over another sub-band.

The destination, the sources and the relays attempt to decode the received messages at the end of a time slot. The success of the decoding on each node is decided by using the CRC. The destination and the nodes thus determine their set of correctly decoded sources.

According to the embodiment, during the second phase, for the time slot (also referred to as round) t, the destination d transmits its set of correctly decoded sources at the end of the previous time slot [symbol] _{d,t-1} using, for example, a feedback broadcast control channel, t={1, . . . , T_{used}}. This feedback can include a vector of M bits.

If the decoding of all the sources by the destination is correct [symbol] _{d,t-1}=S, the current cycle is stopped; a new cycle can start. A transmission cycle for a new frame starts with the erasure of the relays and the destination from the memories and with the transmission of new messages by the sources. The number of time slots (rounds) used during the second phase T_{used}={1, . . . , Tₘₐₓ} depends on the decoding success at the destination.

The nodes, sources and relays compare the set [symbol] _{d,t-1} of sources correctly decoded by the destination with their set of correctly decoded sources [symbol] _{r,t-1} and deduce the set of sources [symbol] ′_{r,t-1} therefrom for which they can assist the destination: [symbol] ′_{r,t-1}= [symbol] _{r,t-1}∩ [symbol] _{d,t-1}. By convention, [symbol] _{c,t}⊆ [symbol] denotes the set of messages (or sources) correctly decoded by the node c∈ [symbol] ∪ [symbol] ∪{d} at the end of the time slot t (round t), t∈{0, . . . , Tₘₐₓ} including its own message for a source. The end of the time slot (round) t=0 corresponds to the end of the first phase. The number of time slots used during the second phase T_{used}={1, . . . , Tₘₐₓ} depends on the decoding success at the destination.

If the set of a node comprises at least one source not included in the set [symbol] _{d,t-1} of the destination, the node notifies the destination accordingly using, for example, a dedicated control channel of the unicast type. The information transmitted by a node can include the set of sources thereof for which it has correct knowledge, i.e. that it has correctly decoded, including knowledge of its own message for a source, [symbol] _{r,t-1} [symbol] or, as illustrated in FIG. 4, can include the sources for which it has correct knowledge and that the destination has not yet correctly decoded, [symbol] ′_{r,t-1}= [symbol] _{r,t-1}∩ [symbol] _{d,t-1}.

During this second phase, the destination follows a certain strategy in order to select the one or more sources to assist. The destination notifies the nodes of this selection by transmitting the vector ŝₜ of the sources to be assisted for each sub-band using, for example, a feedback broadcast control channel. The vector ŝₜ defines a partition for the sources to be assisted on the sub-bands, respectively.

The destination thus controls the transmission of the nodes using a feedback channel. This improves spectral efficiency and reliability by increasing the probability of the destination decoding all the sources.

For each source of the partition, all the nodes that have correct knowledge of this source transmit, for the slot t, the same redundancy of this same source over one or more of the same sub-bands. The set of redundancies transmitted for the slot t is denoted RVX_{ŝ}_{ₜ}.

The nodes and the destination can improve their own decoding by exploiting the retransmission of a redundancy of a source over one or more sub-bands they do not transmit over, and accordingly update their set of correctly decoded sources.

### Selection Strategies

The selection of the source to be assisted for each sub-band depends on the state of the channel between the various nodes that transmit the same redundancy and the destination. The state of a channel can be assessed using the mutual information that is a function of the SNR of this channel/link.

By exploiting reference signals (pilot symbols, SRS signals of the 3GPP LTE, etc.), the destination can determine the gains (CSI: Channel State Information) of the direct links per sub-band b∈{1, . . . , B}: h_{dir,b}={hₛ_{₁}_{,b}, . . . , hₛ_{_{M}}_{,b}, hᵣ_{₁}_{,b}, . . . , hᵣ_{_{L}}_{,b}}, i.e. source-to-destination and relay-to-destination links and therefore can deduce the average SNR of these links therefrom. The channel statistic of each link is assumed to follow a centered circular complex Gaussian distribution and the statistics are independent between the links. It is then sufficient to consider only the average SNR as a measure of the statistic of a link.

The signal received by the destination for the retransmission slot t over the sub-band b can be expressed as:

y_{d,t,b}=h_{eq,A}_{ᵢ}_{,t,b}xₛ_{ᵢ}+z_{t,b} (2)

### With:

Aᵢ being the set of nodes with correct knowledge of the source sᵢ at the end of the time slot t−1;
h_{eq,A}_{ᵢ}_{,t,b} being the equivalent channel resulting from the transmission during the retransmission slot t over the sub-band b by all the nodes belonging to Aᵢ with the same redundancy version RVXₛ_{ᵢ}; and
z_{t,b} being a complex circularly-symmetric Gaussian random variable such that

$${z}_{t , b} ∼ C \text{?} ( 0 , 2 {σ}^{2} ) ( E [ {z}_{t , b}^{2} ] = 0 and E [ {\vert {z}_{t , b} \vert}^{2} ] = 2 {σ}^{2} ) .$$

The transmission during the 2^{nd} phase, by the nodes with correct knowledge of a source to be assisted that is selected and identified in the vector St, can proceed according to several embodiments.

According to a first embodiment, none of the nodes a∈Aᵢ, Aᵢ forming the set of nodes with correct knowledge of the source i (i.e. of the message u; transmitted by the source sᵢ) at the end of the slot t−1, knows the phase φ_{a,b} of the transmission channel h_{a,b} over the sub-band b linking it to the destination d. The equivalent channel for a source sᵢ to be assisted over the sub-band b then can be expressed as:

$${h}_{eq , {A}_{i} , t , b} = \sqrt{P} {Σ}_{j ∈ {A}_{i}} \frac{{h}_{j , b}}{\sqrt{{n}_{t , j}}} .$$

This embodiment corresponds to a non-coherent combination upon reception.

According to a second embodiment, each of the nodes a∈Aᵢ, Aᵢ forming the set of nodes with correct knowledge of the source i (i.e. of the message uᵢ transmitted by the source sᵢ) at the end of the slot t−1, knows the phase φ_{a,b} of the transmission channel h_{a,b} over the sub-band b linking it to the destination d.

Upon reception of the vector ŝₜ of sources sᵢ to be assisted, each node a∈Aᵢ transmits, for the retransmission slot t over the same sub-band b, the same redundancy for the message uᵢ transmitted by the source sᵢ modulated by a phase factor

$${e}^{- {j φ}_{a , b}} = {h}_{a , b}^{*} / \vert {h}_{a , b} \vert ,$$

with j²−−1 and where

$${h}_{a , b}^{*} / \vert {h}_{a , b} \vert$$

corresponds to the conjugate

$${h}_{a , b}^{*}$$

of the transmission channel h_{a,b} linking the node a to the destination d divided by its norm |h_{a,b}|, so that all these redundancies transmitted by the nodes a∈Aᵢ are coherently received at the same time by the destination. Thus, the equivalent channel for the assisted source sᵢ over the sub-band b is expressed as:

$${h}_{eq , {A}_{i} , t , b} = \sqrt{P} {\sum }_{j ∈ {A}_{i}} \frac{\vert {h}_{j , p} \vert}{\sqrt{{n}_{t , j}}} .$$

Such a transmission mode, called “equal gain combining”, allows, on the destination side, a coherent combination to be obtained of the set of signals transmitted by the nodes with correct knowledge of the message transmitted by the selected source sᵢ-According to a third embodiment, the set Aᵢ of nodes with correct knowledge of the source i at the end of the slot t−1 is divided into two groups of nodes, Di and Et. Each node of the first group of nodes, a∈Dᵢ, knows the phase φ_{a,b} of the transmission channel h_{a,b} over the sub-band b linking it to the destination d. Each node of the second group, a∈Eᵢ does not know the phase φ_{a,b} of the transmission channel over the sub-band b linking it to the destination d. Upon reception of the vector St of sources to be assisted, each node of the first group, a∈Dᵢ, transmits, for the retransmission slot t over the same sub-band b, the same redundancy for the message uᵢ transmitted by the source sᵢ modulated by a phase factor

$${e}^{- j {φ}_{a , b}} = {h}_{a , b}^{*} / \vert {h}_{a , b} \vert ,$$

with j²=−1 and where

$${h}_{a , b}^{*} / \vert {h}_{a , b} \vert$$

corresponds to the conjugate

$${h}_{a , b}^{*}$$

of the transmission channel h_{a,b} linking the node a to the destination d divided by its norm |h_{a,b}|, so that all these redundancies transmitted by the nodes of the first group are coherently received by the destination at the same time. Furthermore, each node belonging to the second group Eᵢ transmits, for the retransmission slot t over the same sub-band b, the same redundancy for the message uᵢ transmitted by the source sᵢ without phase modulation.

This embodiment can be used, for example, during a transient period, during which the destination has not yet been able to determine the information relating to the phase factors e^{-jφ}^{_{a,b}} for all the nodes. Over time, the destination can provide all the nodes of the system with such information, further improving transmission quality.

According to this embodiment, the equivalent channel can be expressed as:

$${h}_{eq , {A}_{i} , t , b} = \sqrt{P} ( {\sum }_{j ∈ {D}_{i}} \frac{\vert {h}_{j , b} \vert}{\sqrt{{n}_{t , j}}} + {\sum }_{j ∈ {E}_{i}} \frac{\vert {h}_{j , b} \vert}{\sqrt{{n}_{t , j}}} ) .$$

For all these embodiments, the signal-to-noise ratio associated with the equivalent channel is

$$SNR ( {A}_{i} , t , b ) = \frac{{\vert {h}_{eq , {A}_{i} , t , b} \vert}^{2}}{2 {σ}^{2}}$$

assuming that [symbol] {|xₛ_{ᵢ}|²}=1.

The mutual information I_{A}_{ᵢ}_{,t,b} associated with the equivalent channel is a function of the SNR, i.e. I_{A}_{ᵢ}_{,t,b}=I(SNR(Aᵢ,t,b)).

The transmission power of a node is frequency-shared between the various sub-bands for which the node is active for the same retransmission slot and cannot exceed the maximum power P. Consequently, the mutual information associated with the equivalent channel, I_{A}_{ᵢ}_{,t,f} with i∈{1, . . . , M}, f∈{1, . . . , B}, and t∈{1, . . . , Tₘₐₓ} depends on the number of sub-bands n_{t,j} for which the node j that belongs to the set Aᵢ is active, i.e. transmits a redundancy for the same source or for multiple sources for these various sub-bands.

The selection of the sources to be assisted takes into account the fact that each node that transmits a redundancy of a selected source to be assisted transmits over the allocated sub-bands and does so for the various sources to be assisted for which it has correct knowledge. The selection of the sources is therefore subject to the constraint that the transmission power for each node that transmits is distributed over the sub-bands for which it is active. According to a first selection mode implemented in algorithm 1 of the appendix, for a retransmission slot t, the scheduler considers all the possible vectors, sₜ∈{1, . . . , M}^{B}, of sources of size B taken from among the sources to be assisted, i.e. these sources are taken from among the sources not yet decoded by the destination [symbol] _{d,t-1}. The selected vector is that which allows the largest mutual information to be provided, knowing that the mutual information depends, for each sub-band, on the equivalent channel between the various nodes that transmit the same redundancy and the destination. The optimal vector of sources to be assisted for the sub-bands B, ŝₜ∈{1, . . . , M}^{B} from among these various possible vectors is as follows:

$${\hat{s}}_{t} ∈ {argmax}_{s ∈ {\{ {\overline{S}}_{d , t - 1} \}}^{B}} \{ {\sum }_{f = 1}^{B} {I}_{{A}_{{s}_{f}} , t , f} \} .$$

Thus, the optimal vector St for the retransmission slot t comprises all the sources for which the sum over the sub-bands B of the mutual information, I_{As}_{_{f}}_{,t,f}, is the highest, with each item of mutual information being associated with the equivalent transmission channel established between each node with error-free knowledge of the same source to be assisted, s∈{S̅_{d,t-1}}, and the destination.

In other words, the destination selects the vector of sources to be assisted for which the average “harvested” mutual information is the greatest. This average mutual information is a sum dependent on the equivalent SNR per sub-band, thus the optimization must be combined on all the sub-bands because the power transmitted by a node must be shared between the sub-bands for which the node is active.

According to a second selection mode implemented in algorithm 2 of the appendix, the destination sequentially selects the sources to be assisted, sub-band after sub-band. Thus, for a retransmission slot t, for each of the sub-bands b taken successively, the destination selects, from among the sources to be assisted, the source denoted ŝ_{t,b}, such that:

$${\hat{s}}_{t , b} ∈ {argmax}_{s ∈ {\overline{S}}_{d , t - 1}} \{ {\sum }_{f = 1}^{b - 1} {I}_{{A}_{{\hat{s}}_{f}} , t , f} + {I}_{{A}_{s} , t , b} \} .$$

The selected source ŝ_{t,b} for the sub-band b is the source, from among the sources to be assisted, s∈S̅_{d,t-1}, that maximizes the sum comprising, on the one hand, the sum over the sub-bands from 1 to b−1 of the mutual information of the equivalent channel for each of these sub-bands,

$${\sum }_{f = 1}^{b - 1} {I}_{{A}_{{\hat{s}}_{f}} , t , f} ,$$

and, on the other hand, the mutual information of the equivalent channel of the sub-band b, I_{A}_{ₛ}_{,t,b}.

This 2^{nd} selection mode is less complex than the 1^{st} mode.

Of course, each selection mode is combined with the various transmission modes described above.

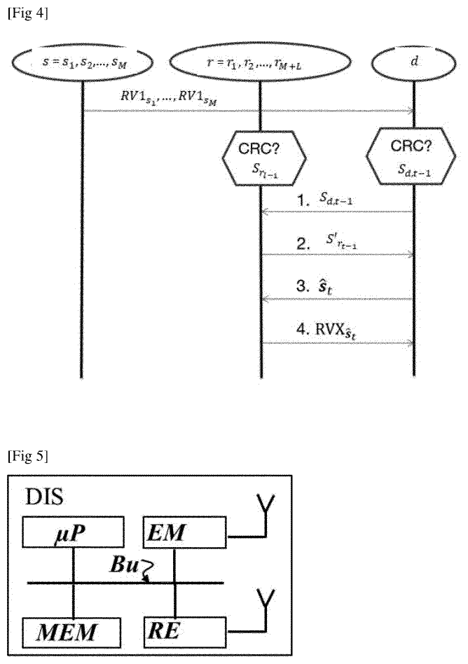

FIG. 5 is a diagram of the simplified structure of an embodiment of a telecommunication device DIS according to one embodiment of the invention.

This device DIS is intended for an OMAMRC telecommunication system comprising N nodes including M sources sᵢiϵ{1, . . . , M} and N−M relays, N≥M≥2, and a destination d.

Access to the transmission channel between the nodes and the destination is of the orthogonal multiple type. The protocol of the exchanges between the nodes and the destination defines a maximum number T+Tₘₐₓ of time slots per transmitted frame distributed between a 1^{st} phase of T time slots and a 2^{nd} phase of at least one time slot, called retransmission time slot, 1≤Tₘₐₓ.

The device DIS comprises at least one microprocessor μP whose operation is controlled by executing a program Pg whose instructions allow a transmission method according to the invention to be implemented, a memory MEM, a transmission chain EM and a reception chain RE that are connected to each other through a bus Bu. Of course, the constituent elements of the device DIS can be connected by means of a connection other than a bus.

The microprocessor μP controls the operations of the device DIS. The storage unit MEM stores at least the program Pg for implementing the method according to one embodiment of the invention to be executed by the processor μP, and miscellaneous data, such as parameters used for computations carried out by the microprocessor μP, intermediate data for computations carried out by the microprocessor μP, etc. The microprocessor μP can be formed by any known and appropriate hardware or software, or by a combination of hardware and software. For example, the microprocessor μP can be formed by dedicated hardware, such as a processing circuit, or by a programmable processing unit, such as a central processing unit that executes a program stored in a memory thereof.

The memory MEM can be formed by any suitable means capable of storing the program Pg or the programs and data in a computer-readable manner. Examples of a memory MEM include non-transitory computer-readable storage media, such as semiconductor memory devices, and magnetic, optical, or magneto-optical storage media loaded into a read and write unit.

On initialization, the code instructions of the program Pg are loaded, for example, into a buffer memory before being executed by the processor μP. The microprocessor μP controls the various components of the device DIS.

Thus, by executing the instructions, the microprocessor μP allows the device DIS to implement the transmission method according to one embodiment of the invention.

According to one embodiment of the invention, the device DIS is one of the M sources sᵢ i_{ϵ}{1, . . . , M}. According to this embodiment, the device DIS can be a mobile terminal.

According to this embodiment, the device DIS is able to transmit a frame message. Of course, the device can successively transmit several messages. The transmission method implemented by the device is such that it comprises incremental redundancy type coding implemented by a coder of the transmission chain EM that generates several redundancies of the same message to be transmitted. The transmission by the device is of the frequency division multiplexing type over a band divided into B mutually orthogonal sub-bands, M≤BT. The method for transmitting via the device DIS further comprises:
transmitting a first redundancy of the message to be transmitted during the 1^{st} phase, implemented by the transmission chain EM;
receiving scheduling information ŝₜ indicating, per sub-band, a selected source, called source to be assisted, not yet correctly decoded by the destination with the scheduling information taking into account a constraint of a maximum transmission power per node, implemented by the reception chain RE;
transmitting, during a retransmission slot of the 2^{nd} phase, a second redundancy of the message of the selected sources over the respective sub-bands, for the sources for which the device has correct knowledge, implemented by the transmission chain EM.

By executing the instructions, the microprocessor μP checks that the transmission of the device DIS over several sub-bands does not exceed the maximum transmission power constraint of this device.

According to one embodiment of the invention, the device DIS corresponds to the destination d of the OMAMRC telecommunication system. According to this embodiment, the device can be a base station. This device is then intended for an OMAMRC telecommunication system comprising N nodes and this device, which acts as the destination d.

Thus, by executing the instructions, the microprocessor μP allows the device DIS to implement the transmission method, which comprises:
simultaneously receiving, during the 1^{st} phase over at least M sub-bands, M first redundancies of the M messages of the M sources, implemented by the reception chain RE;
transmitting scheduling information ŝₜ indicating, per sub-band, a selected source, called source to be assisted, not yet correctly decoded by the device with the scheduling information taking into account a constraint of a maximum transmission power per node, implemented by the transmission chain EM;
receiving, over the same sub-band for the same retransmission slot of the 2^{nd} phase, the same second redundancy of the same selected source sᵢ and originating from various nodes with correct knowledge of this same source, implemented by the reception chain RE.

### APPENDIX

Algorithm 1 selection strategy

| | | |
|---|---|---|
| 1. | t ← 1 | Initialization of the index of the current |
| | | retransmission slot |
| 2. | \| While (S̅_{d,t-1} ≠ φ and t ≤ Tₘₐₓ) then | The transmission of a frame is complete |
| | \| | when all the sources are correctly decoded |
| | \| | or when the current time indicator reaches |
| | \| | Tₘₐₓ |
| 3. | \| S_{d,t-1} | The destination d sends the nodes its set of |
| | \| | correctly decoded sources |
| 4. | \| ${S}_{r , t - 1}^{′} = {S}_{r , t - 1} ∩ {\overline{S}}_{d , t - 1}$ \| | The nodes r send the destination their set of correctly decoded and not yet correctly |
| | \| | decoded sources by the destination |
| 5. | $\vert {\hat{s}}_{t} ∈ {arg max}_{s ∈ {\{ {\overline{S}}_{d , t - 1} \}}^{B}} \{ {\sum }_{f = 1}^{B} {{I}_{A}}_{{s}_{f} , t , f} \}$ | The destination determines the optimal vector ŝₜ of the sources to be assisted |
| 6. | \| ŝₜ | The destination d sends the nodes the |
| | \| | optimal vector ŝₜ |
| 7. | \| RVX\hat{ₛ}_{_{t,b}} | The nodes with correct knowledge of the |
| | \| | source ŝ_{t,b} at the same time transmit the |
| | \| | same redundancy RVX\hat{ₛ}_{_{t,b}} over the same |
| | \| | sub-band b during the time slot t |
| 8. | \| t ← t + 1 | Incrementation of the index of the current |
| | \| | retransmission slot |
| 9. | \| End while | |

Algorithm 2 selection strategy

| | | |
|---|---|---|
| 1. | t ← 1 | Incrementation of the index of the |
| | | current retransmission slot |
| 2. | \| While (S_{d,t-1} ≠ φ and t ≤ Tₘₐₓ) then | The transmission of a frame is complete |
| | \| | when all the sources are correctly |
| | \| | decoded or when the current time |
| | \| | indicator reaches Tₘₐₓ |
| 3. | \| S_{d,t-1} | The destination d sends the nodes its set |
| | \| | of correctly decoded sources |
| 4. | \| ${S}_{r , t - 1}^{′} = {S}_{r , t - 1} ∩ {\overline{S}}_{d , t - 1}$ \| | The nodes r send the destination their set of correctly decoded sources |
| 5. | \| \| from b = 1 to b = B | For each sub-band b of the band B |
| 6. | $\vert \vert {\hat{s}}_{t , b} ∈ {arg max}_{s ∈ {\overline{S}}_{d , t - 1}} \{ {\sum }_{f = 1}^{b - 1} {{I}_{A}}_{{\hat{s}}_{t , f} , t , f} + {I}_{{A}_{s} , t , b} \}$ | The destination determines the optimal vector ŝ_{t,b} of the sources to be assisted per sub-band |
| 7. | \| \| end for | |
| 8. | \| ŝₜ | The destination d sends the nodes the |
| | | optimal vector ŝₜ |
| 9. | \| The nodes with correct knowledge of | |
| | \| the source ŝ_{t,b} at the same time | |
| | \| transmit the same redundancy over the | |
| | \| same sub-band b during the time slot t | |
| 10. | \| t ← t + 1 | Incrementation of the index of the |
| | | current retransmission slot |
| 11. | \| End while | |

1. A transmission method implemented by a telecommunication system for transmitting framed messages, the telecommunication system comprising a destination and N nodes, including M sources (and N−M relays, N≥M≥2, with orthogonal multiple access to a transmission channel between the N nodes, with a maximum number of T+Tₘₐₓ time slots per transmitted frame distributed between a 1^{st} phase of T time slots and a 2^{nd} phase of at least one time slot, called retransmission time slot, 1≤Tₘₐₓ, with the message of a source having been coded before transmission according to incremental redundancy type coding that generates several redundancies, the transmission being of a frequency division multiplexing type over a band divided into B≥2 mutually orthogonal sub-bands, M≤BT, such that wherein the method comprises:
transmitting M first redundancies of the M messages of the M sources during the 1^{st} phase;
receiving, by the nodes, scheduling information indicating, per sub-band, a selected source, called source to be assisted, not yet correctly decoded by the destination, the scheduling information taking into account a constraint of a maximum transmission power per node; and
transmitting, over the same sub-band for a same retransmission slot of the 2^{nd} phase, by nodes, called active nodes, with correct knowledge of the same selected source, of a same second redundancy of the same message of the same source, with the transmission of a node over several sub-bands being subject to the constraint of a maximum transmission power of the node.

2. The transmission method as claimed in claim 1, further comprising:
transmitting sets of sources correctly decoded by the nodes at the end of the transmission slot of the 1^{st} phase.

3. The transmission method as claimed in claim 1, further comprising:
receiving, by the nodes, a set of sources correctly decoded by the destination from among the sources received by the destination during the 1^{st} phase;
transmitting, by the nodes, sets of sources correctly decoded by the nodes and not yet correctly decoded by the destination at the end of the 1^{st} phase.

4. The transmission method as claimed in claim 1, wherein the scheduling information is obtained by comparing, between different possible scheduling information of sources to be assisted per sub-band, a sum on the sub-bands B of mutual information per sub-band b of an equivalent channel between the nodes with correct knowledge of the same source to be assisted and the destination.

5. The transmission method as claimed in claim 1, wherein, with the scheduling information comprising B components, the components are determined sequentially, sub-band after sub-band and, for a given sub-band b, the component is obtained by determining, between the various sources to be assisted, a maximum of a sum, the sum comprising the sum on the sub-bands of 1 to b−1 of mutual information of an equivalent channel between the nodes with correct knowledge of the same source to be assisted and the destination, and mutual information of an equivalent channel between the nodes with correct knowledge of the same source to be assisted and the destination for the sub-band b.

6. The transmission method as claimed in claim 1, with a transmission channel between a node a taken from among the N nodes and the destination for the sub-band b being expressed as h_{a,b} e^{-jφ}^{_{a,b}}, with h_{a,b} being an amplitude and φ_{a,b} being a phase factor, the method is such that, when each of the nodes with correct knowledge of the same selected source knows the phase φ_{a,b} of the transmission channel between this node a and the destination, the transmission, by each of these nodes, of the same second redundancy of this same source is modulated by the phase factor
$${e}^{- j {φ}_{a , b}} = {h}_{a , b}^{*} / \vert {h}_{a , b} \vert ,$$
with j²=−1 and where
$${h}_{a , b}^{*} / \vert {h}_{a , b} \vert$$
corresponds to the conjugate
$${h}_{a , b}^{*}$$
of the amplitude h_{a,b} of the transmission channel between this node and the destination divided by a norm |h_{a,b}| of the transmission channel.

7. The transmission method as claimed in claim 1, wherein a transmission channel between a node a taken from among the N nodes and the destination for the sub-band b is expressed as h_{a,d} e^{-jφ}^{_{a,b}}, with h_{a,d} being an amplitude and φ_{a,b} being a phase factor, with the nodes with correct knowledge of the same source selected for the sub-band b being grouped into a first and a second group of nodes, such that each node of the first group knows the phase φ_{a,b} of the transmission channel between this node and the destination for the sub-band b and each node of the second group does not know the phase φ_{a,b} of the transmission channel between this node and the destination for the sub-band b, the method is such that the transmission via a node a of the first group of the same second redundancy of the source selected for the sub-band b is modulated by the phase factor
$${e}^{- j {φ}_{a , b}} = {h}_{a , b}^{*} / \vert {h}_{a , b} \vert ,$$
with j²=−1 and where
$${h}_{a , b}^{*} / \vert {h}_{a , b} \vert$$
corresponds to the conjugate
$${h}_{a , b}^{*}$$
of the amplitude h_{a,b} of the transmission channel between this node a and the destination divided by a norm |h_{a,b}| of the transmission channel, and such that the transmission via a node a of the second group of the same second redundancy of the source selected for the sub-band b occurs without phase correction.

8. A transmission method for transmitting framed messages implemented by a telecommunication device intended for a telecommunication system with N nodes including M sources and N−M relays and the device, N≥M≥2, with orthogonal multiple access to the transmission channel between the N nodes, with a maximum number of T+Tₘₐₓ time slots per transmitted frame distributed between a 1^{st} phase of T time slots and a 2^{nd} phase of at least one time slot, called retransmission time slot, 1≤Tₘₐₓ, with the message of a source having been coded before transmission according to incremental redundancy type coding that generates several redundancies, the transmission being of the frequency division multiplexing type over a band divided into B mutually orthogonal sub-bands, M≤BT, wherein the method comprises: simultaneously receiving, by the device during the 1^{st} phase over at least M sub-bands, M first redundancies of the M messages of the M sources;
transmitting scheduling information indicating, per sub-band, a selected source, called source to be assisted, not yet correctly decoded by the device, with the scheduling information taking into account a constraint of a maximum transmission power per node; and
receiving, over a same sub-band for a same retransmission time slot of the 2^{nd} phase, a same second redundancy of the same selected source and originating from various nodes with correct knowledge of this same selected source.

9. The transmission method as claimed in claim 8, further comprising:
transmitting a set of sources correctly decoded by the device from among the sources received by the device during the 1^{st} phase; and
receiving sets of sources correctly decoded by the nodes and not yet correctly decoded by the device at the end of the 1^{st} phase.

10. A transmission method for transmitting framed messages implemented by a telecommunication device intended for a telecommunication system with N nodes including M sources and N−M relays and a destination, N≥M≥2, the telecommunication device forming one of the sources, with orthogonal multiple access to the transmission channel between the N nodes and the destination, with a maximum number of T+Tₘₐₓ time slots per transmitted frame distributed between a 1^{st} phase of T time slots and a 2^{nd} phase of at least one time slot, called retransmission time slot, 1≤Tₘₐₓ, comprising coding of a message before transmission according to incremental redundancy type coding that generates several redundancies, with the transmission being of the frequency division multiplexing type over a band divided into B mutually orthogonal sub-bands, M≤BT, wherein the method further comprises:
transmitting a first redundancy of a message from the source during the 1^{st} phase;
receiving scheduling information (Sz) indicating, per sub-band, a selected source, called source to be assisted, not yet correctly decoded by the destination, with the scheduling information taking into account a constraint of a maximum transmission power per node; and
transmitting, during a retransmission slot of the 2^{nd} phase, a second redundancy of the message of the selected sources over the respective sub-bands, for the sources for which the device has correct knowledge, with the transmission of the device over several sub-bands being subject to the constraint of a maximum transmission power.

11. The transmission method as claimed in claim 10, wherein, for the same source, the first redundancy and the second redundancy are different.

12. The transmission method as claimed in claim 10, wherein the scheduling information is determined based on mutual information, per sub-band b of an equivalent channel between the nodes with correct knowledge of the same source to be assisted and the destination.

13. A telecommunication device for transmitting framed messages,
intended for a telecommunication system comprising N nodes including M sources and N−M relays, N≥M≥2, and a destination-d, with orthogonal multiple access to the transmission channel between the N nodes and the destination, with a maximum number of T+Tₘₐₓ time slots per transmitted frame distributed between a 1^{st} phase of T time slots and a 2^{nd} phase of at least one time slot, called retransmission time slot, 1≤Tₘₐₓ, the transmission being of the frequency division multiplexing type over a band divided into B≥2 mutually orthogonal sub-bands, M≤BT, wherein the device corresponds to one of the sources and comprises:
at least one microprocessor;
a memory;
a transmission chain; and
a reception chain,
wherein:
the transmission chain comprises a coder implementing incremental redundancy type coding that generates multiple redundancies of the same message to be transmitted
the transmission chain is configured to transmit a first redundancy of the message to be transmitted during the 1^{st} phase;
the reception chain is configured to receive scheduling information of size B indicating, per sub-band, a selected source, called source to be assisted, not yet correctly decoded by the destination, the scheduling information taking into account a constraint of a maximum transmission power per node;
the transmission chain is further configured to transmit, during a retransmission slot of the 2^{nd} phase, a second redundancy of the message of the selected sources over the respective sub-bands, for the sources for which the device has correct knowledge, with the transmission over several sub-bands being subject to the constraint of a maximum transmission power.

14. A telecommunication device for transmitting framed messages, intended for a telecommunication system comprising N nodes, including M sources and N−M relays, N≥M≥2, and a destination, with orthogonal multiple access to the transmission channel between the N nodes and the destination, with a maximum number of T+Tₘₐₓ time slots per transmitted frame distributed between a 1^{st} phase of T time slots and a 2^{nd} phase of at least one time slot, called retransmission time slot, 1≤Tₘₐₓ, the transmission being of the frequency division multiplexing type over a band divided into B≥2 mutually orthogonal sub-bands, M≤BT, wherein the device corresponds to one of the sources and comprises:
at least one microprocessor;
a memory;
a transmission chain; and
a reception chain, such that:
the reception chain is configured to simultaneously receive, during the 1^{st} phase over at least M sub-bands, M first redundancies of the M messages of the M sources;
the transmission chain is configured to transmit scheduling information indicating, per sub-band, a selected source, called source to be assisted, not yet correctly decoded by the device, the scheduling information taking into account a constraint of a maximum transmission power per node;
the reception chain is configured to receive, over the same sub-band for the same retransmission slot of the 2^{nd} phase, the same second redundancy of the same selected source(s) and originating from various nodes with correct knowledge of this same source.

15. (canceled)

16. (canceled)

17. (canceled)

18. The transmission method as claimed in claim 1, wherein, for the same source, the first redundancy and the second redundancy are different.

19. The transmission method as claimed in claim 1, wherein the scheduling information is determined based on mutual information, per sub-band b, of an equivalent channel between the nodes with correct knowledge of the same source to be assisted and the destination.

20. The transmission method as claimed in claim 8, wherein, for the same source, the first redundancy and the second redundancy are different.

21. The transmission method as claimed in claim 8, wherein the scheduling information is determined based on mutual information, per sub-band b, of an equivalent channel between the nodes with correct knowledge of the same source to be assisted and the destination.
